(19) United States
(12) Patent Application Publication
(10) Pub. No.: US 2024/0397554 A1
(43) Pub. Date: Nov. 28, 2024

(54) USER EQUIPMENT BASED POWER BOOSTING FOR RETRANSMISSION OF MESSAGE 3 OF RANDOM ACCESS CHANNEL PROCEDURE

(71) Applicant: QUALCOMM Incorporated, San Diego, CA (US)

(72) Inventors: Guiyin ZHOU, Beijing (CN); Hui ZHAO, San Diego, CA (US); Junli WU, Beijing (CN); Yinxiong YAO, Beijing (CN); Bo WANG, Shanghai (CN); Yue WANG, Shanghai (CN)

(21) Appl. No.: 18/691,731

(22) PCT Filed: Dec. 2, 2021
(86) PCT No.: PCT/CN2021/134972

§ 371 Date: Mar. 13, 2024

(51) Int. Cl. H04W 74/0833; H04L 1/08; H04W 52/34; H04W 52/54

(52) U.S. Cl. CPC H04W 74/0833; H04L 1/08; H04W 52/34; H04W 52/54

(57) ABSTRACT

Various aspects of the present disclosure generally relate to wireless communication. In some aspects. a user equipment (UE) may transmit a first message of a four-step random access channel (RACH) procedure to a base station. The UE may receive a second message of the four-step RACH procedure. The UE may transmit a third message of the four-step RACH procedure. The UE may determine that the third message was not successfully decoded by the base station. The UE may retransmit the third message based at least in part on applying a power boosting algorithm to increase an uplink transmission power. wherein the power boosting algorithm is applied based at least in part on a power offset between the third message and the first message satisfying a threshold and a transmit power control (TPC) command not being received from the base station. Numerous other aspects are described.

### FIELD OF THE DISCLOSURE

Aspects of the present disclosure generally relate to wireless communication and to techniques and apparatuses for user equipment based power boosting for retransmission of a message 3 of a four-step random access channel procedure.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting a first message of a four-step random access channel (RACH) procedure to a base station. The method may include receiving, from the base station, a second message of the four-step RACH procedure based at least in part on transmitting the first message. The method may include transmitting, to the base station and utilizing an initial uplink transmission power, a third message of the four-step RACH procedure. The method may include determining that the third message was not successfully decoded by the base station. The method may include retransmitting the third message based at least in part on applying a power boosting algorithm to increase an uplink transmission power, wherein the power boosting algorithm is applied based at least in part on a power offset between the third message and the first message satisfying a threshold and based at least in part on a transmit power control (TPC) command associated with retransmitting the third message not being received from the base station.

Some aspects described herein relate to a method of wireless communication performed by a base station. The method may include receiving, from a UE, a first message of a four-step RACH procedure. The method may include transmitting, to the UE, a second message of the four-step RACH procedure based at least in part on receiving the first message. The method may include receiving a third message of the four-step RACH procedure, wherein the base station fails to successfully decode the third message. The method may include receiving a retransmission of the third message based at least in part on the UE applying a power boosting algorithm to increase the uplink transmission power, wherein the power boosting algorithm is applied based at least in part on a power offset between the third message and the first message satisfying a threshold and based at least in part on a TPC command associated with retransmitting the third message not being received from the base station.

Some aspects described herein relate to a UE for wireless communication. The user equipment may include a memory and one or more processors coupled to the memory. The one or more processors may be configured to transmit a first message of a four-step RACH procedure to a base station. The one or more processors may be configured to receive, from the base station, a second message of the four-step RACH procedure based at least in part on transmitting the first message. The one or more processors may be configured to transmit, to the base station and utilizing an initial uplink transmission power, a third message of the four-step RACH procedure. The one or more processors may be configured to determine that the third message was not successfully decoded by the base station. The one or more processors may be configured to retransmit the third message based at least in part on applying a power boosting algorithm to increase an uplink transmission power, wherein the power boosting algorithm is applied based at least in part on a power offset between the third message and the first message satisfying a threshold and based at least in part on a TPC command associated with retransmitting the third message not being received from the base station.

Some aspects described herein relate to a base station for wireless communication. The base station may include a memory and one or more processors coupled to the memory. The one or more processors may be configured to receive, from a UE, a first message of a four-step RACH procedure. The one or more processors may be configured to transmit, to the UE, a second message of the four-step RACH procedure based at least in part on receiving the first message. The one or more processors may be configured to receive a third message of the four-step RACH procedure, wherein the base station fails to successfully decode the third message. The one or more processors may be configured to receive a retransmission of the third message based at least in part on the UE applying a power boosting algorithm to increase the uplink transmission power, wherein the power boosting algorithm is applied based at least in part on a power offset between the third message and the first message satisfying a threshold and based at least in part on a TPC command associated with retransmitting the third message not being received from the base station.

Some aspects described herein relate to a non-transitory computer-readable medium that stores a set of instructions for wireless communication by a UE. The set of instructions, when executed by one or more processors of the UE, may cause the UE to transmit a first message of a four-step RACH procedure to a base station. The set of instructions, when executed by one or more processors of the UE, may cause the UE to receive, from the base station, a second message of the four-step RACH procedure based at least in part on transmitting the first message. The set of instructions, when executed by one or more processors of the UE, may cause the UE to transmit, to the base station and utilizing an initial uplink transmission power, a third message of the four-step RACH procedure. The set of instructions, when executed by one or more processors of the UE, may cause the UE to determine that the third message was not successfully decoded by the base station. The set of instructions, when executed by one or more processors of the UE, may cause the UE to retransmit the third message based at least in part on applying a power boosting algorithm to increase an uplink transmission power, wherein the power boosting algorithm is applied based at least in part on a power offset between the third message and the first message satisfying a threshold and based at least in part on a TPC command associated with retransmitting the third message not being received from the base station.

Some aspects described herein relate to a non-transitory computer-readable medium that stores a set of instructions for wireless communication by a base station. The set of instructions, when executed by one or more processors of the base station, may cause the base station to receive, from a UE, a first message of a four-step RACH procedure. The set of instructions, when executed by one or more processors of the base station, may cause the base station to transmit, to the UE, a second message of the four-step RACH procedure based at least in part on receiving the first message. The set of instructions, when executed by one or more processors of the base station, may cause the base station to receive a third message of the four-step RACH procedure, wherein the base station fails to successfully decode the third message. The set of instructions, when executed by one or more processors of the base station, may cause the base station to receive a retransmission of the third message based at least in part on the UE applying a power boosting algorithm to increase the uplink transmission power, wherein the power boosting algorithm is applied based at least in part on a power offset between the third message and the first message satisfying a threshold and based at least in part on a TPC command associated with retransmitting the third message not being received from the base station.

Some aspects described herein relate to an apparatus for wireless communication. The apparatus may include means for transmitting a first message of a four-step RACH procedure to a base station. The apparatus may include means for receiving, from the base station, a second message of the four-step RACH procedure based at least in part on transmitting the first message. The apparatus may include means for transmitting, to the base station and utilizing an initial uplink transmission power, a third message of the four-step RACH procedure. The apparatus may include means for determining that the third message was not successfully decoded by the base station. The apparatus may include means for retransmitting the third message based at least in part on applying a power boosting algorithm to increase an uplink transmission power, wherein the power boosting algorithm is applied based at least in part on a power offset between the third message and the first message satisfying a threshold and based at least in part on a TPC command associated with retransmitting the third message not being received from the base station.

Some aspects described herein relate to an apparatus for wireless communication. The apparatus may include means for receiving, from a UE, a first message of a four-step RACH procedure. The apparatus may include means for transmitting, to the UE, a second message of the four-step RACH procedure based at least in part on receiving the first message. The apparatus may include means for receiving a third message of the four-step RACH procedure, wherein the base station fails to successfully decode the third message. The apparatus may include means for receiving a retransmission of the third message based at least in part on the UE applying a power boosting algorithm to increase the uplink transmission power, wherein the power boosting algorithm is applied based at least in part on a power offset between the third message and the first message satisfying a threshold and based at least in part on a TPC command associated with retransmitting the third message not being received from the base station.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a four-step random access channel (RACH) procedure, in accordance with the present disclosure.

FIG. 4 is a diagram illustrating an example associated with UE-based power boosting for retransmission of a message 3 of a four-step RACH procedure, in accordance with the present disclosure.

FIGS. 5 and 6 are diagrams illustrating example processes associated with UE-based power boosting for retransmission of a message 3 of a four-step RACH procedure, in accordance with the present disclosure.

FIGS. 7 and 8 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

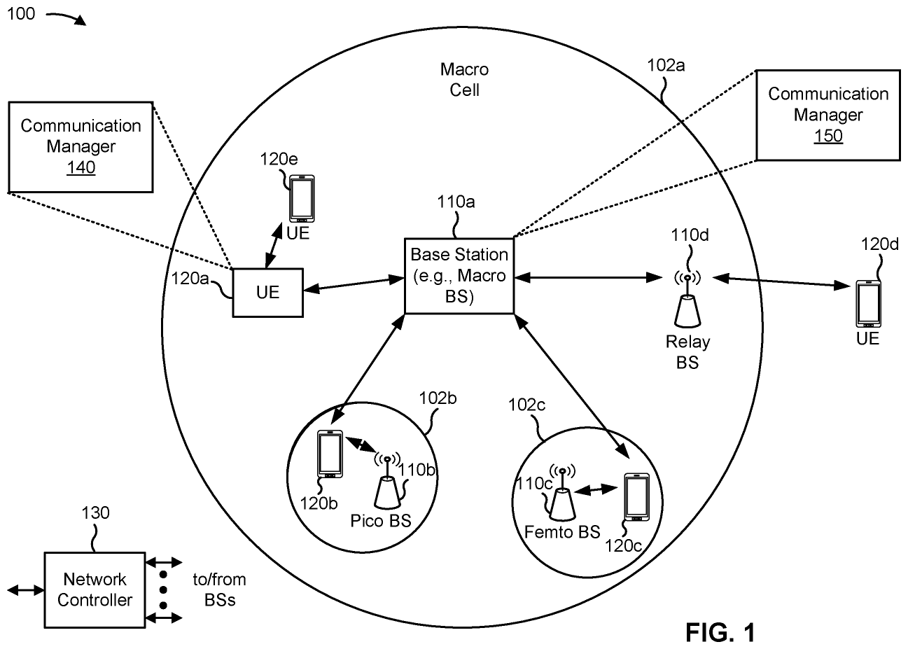

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may perform one or more operations associated with UE power boosting for retransmission of a message 3 of a four-step random access channel (RACH) procedure. Additionally, or alternatively, the communication manager 140 may perform one or more other operations described herein.

In some aspects, the base station 110 may include a communication manager 150. As described in more detail elsewhere herein, the communication manager 150 may perform one or more operations associated with UE-based power boosting for retransmission of a message 3 of a four-step RACH procedure. Additionally, or alternatively, the communication manager 150 may perform one or more other operations described herein.

As indicated above, FIG. 1 is provided as an example. Other examples may differ from what is described with regard to FIG. 1.

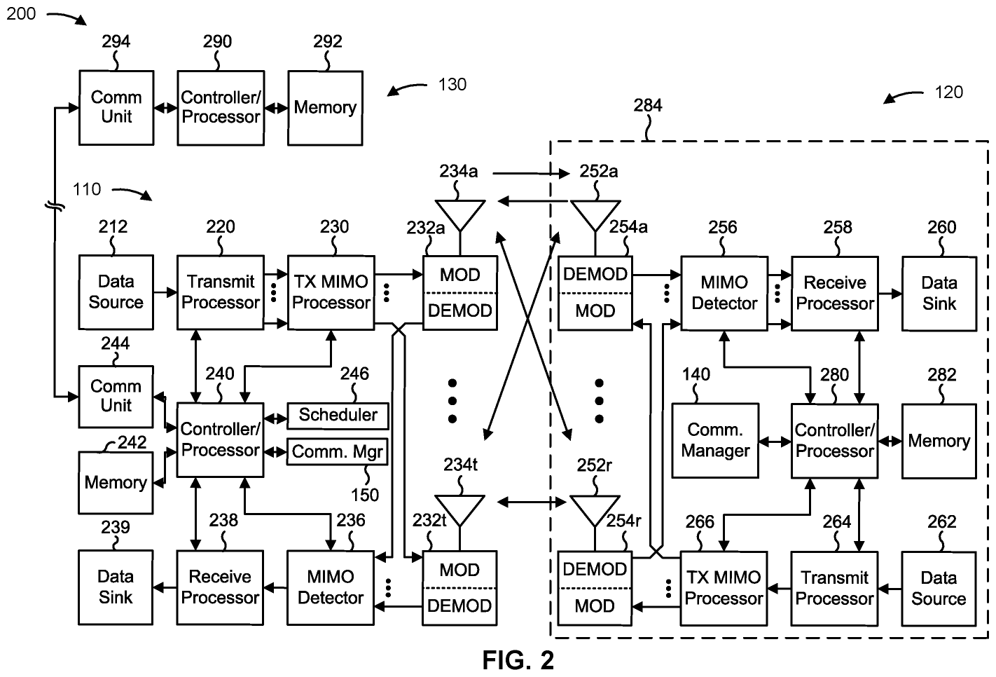

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

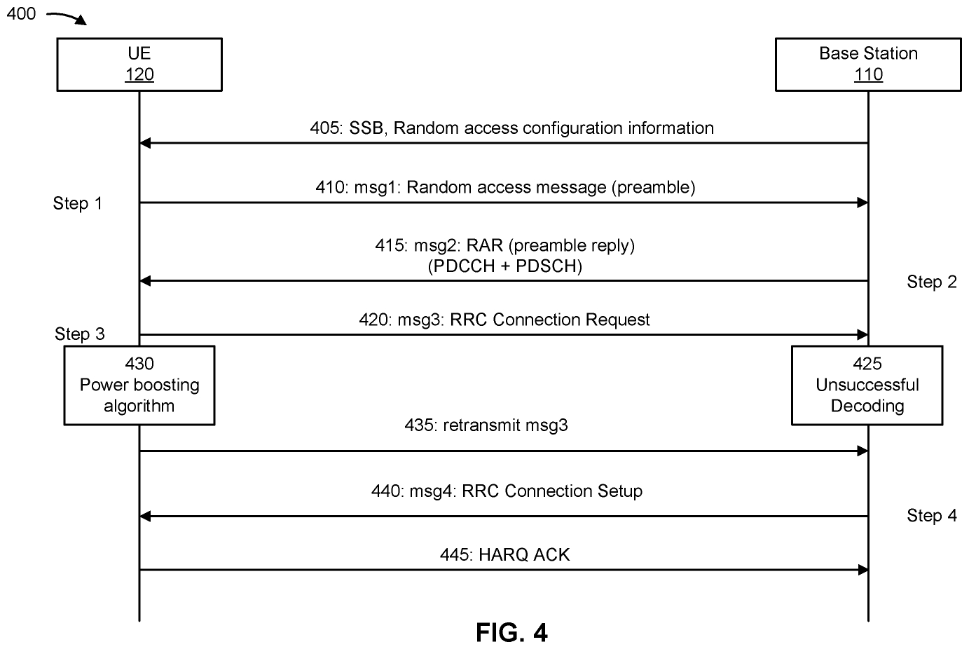

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-8).

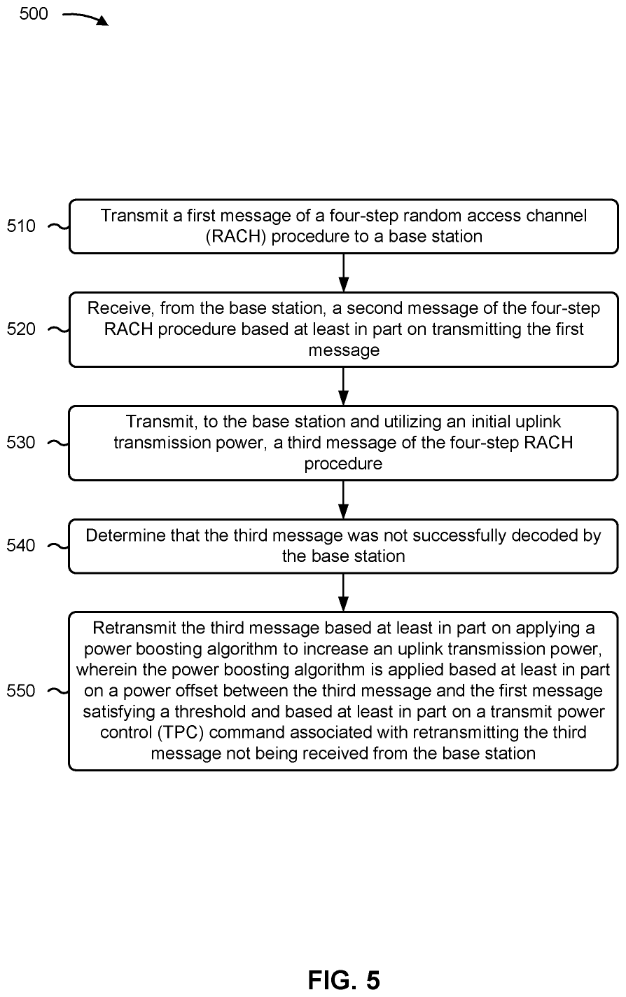

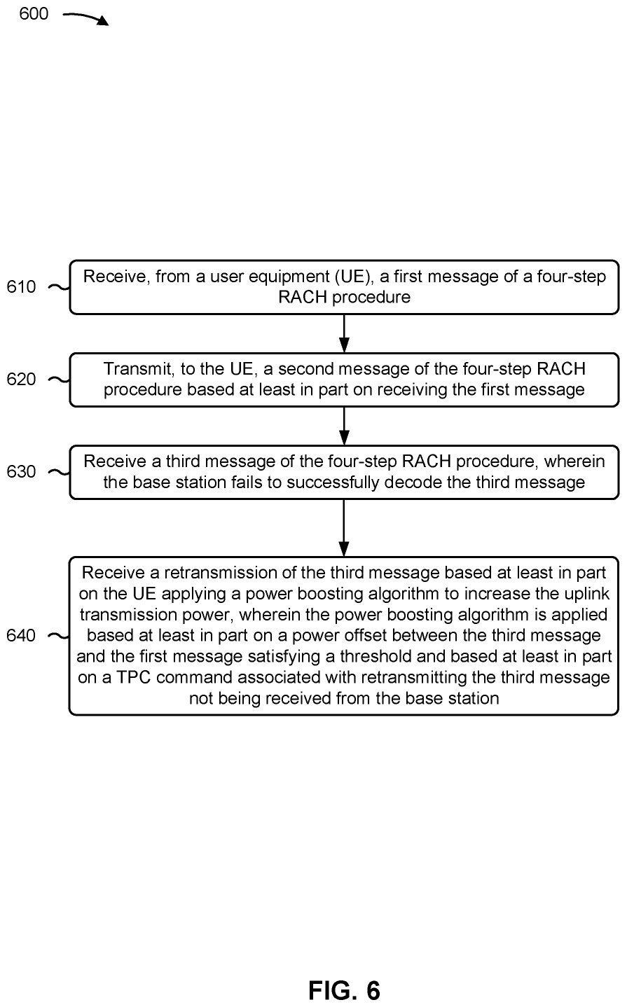

The controller/processor 240 of the base station 110, the controller/processor 280 of the UE 120, and/or any other component(s) of FIG. 2 may perform one or more techniques associated with UE-based power boosting for retransmission of a message 3 of a four-step RACH procedure, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, the UE includes means for transmitting a first message of a four-step RACH procedure to a base station; means for receiving, from the base station, a second message of the four-step RACH procedure based at least in part on transmitting the first message; means for transmitting, to the base station and utilizing an initial uplink transmission power, a third message of the four-step RACH procedure; means for determining that the third message was not successfully decoded by the base station; and/or means for retransmitting the third message based at least in part on applying a power boosting algorithm to increase an uplink transmission power, wherein the power boosting algorithm is applied based at least in part on a power offset between the third message and the first message satisfying a threshold and based at least in part on a TPC command associated with retransmitting the third message not being received from the base station. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for receiving, from a UE, a first message of a four-step RACH procedure; means for transmitting, to the UE, a second message of the four-step RACH procedure based at least in part on receiving the first message; means for receiving a third message of the four-step RACH procedure, wherein the base station fails to successfully decode the third message; and/or means for receiving a retransmission of the third message based at least in part on the UE applying a power boosting algorithm to increase the uplink transmission power, wherein the power boosting algorithm is applied based at least in part on a power offset between the third message and the first message satisfying a threshold and based at least in part on a TPC command associated with retransmitting the third message not being received from the base station. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

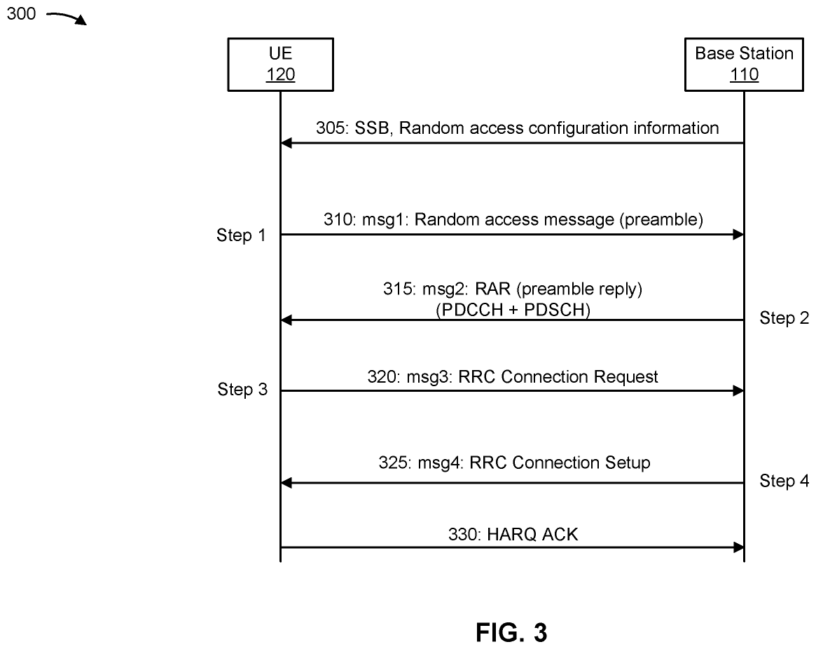

FIG. 3 is a diagram illustrating an example of a four-step random access channel (RACH) procedure, in accordance with the present disclosure. As shown in FIG. 3, a base station 110 and a UE 120 may communicate with one another to perform the four-step RACH procedure.

As shown by reference number 305, the base station 110 may transmit, and the UE 120 may receive, one or more synchronization signal blocks (SSBs) and random access configuration information. In some cases, the random access configuration information may be transmitted in and/or indicated by system information (e.g., in one or more system information blocks (SIBs)) and/or an SSB, such as for contention-based random access. In some cases, the random access configuration information may be transmitted in a radio resource control (RRC) message and/or a physical downlink control channel (PDCCH) order message that triggers a RACH procedure, such as for contention-free random access. The random access configuration information may include one or more parameters to be used in the random access procedure, such as one or more parameters for transmitting a random access message (RAM) and/or one or more parameters for receiving a random access response (RAR).

As shown by reference number 310, the UE 120 may transmit a RAM, which may include a preamble (sometimes referred to as a random access preamble, a PRACH preamble, or a RAM preamble). The RAM that includes the preamble may be referred to as a message 1, msg1, MSG1, a first message, or an initial message in a four-step random access procedure. The RAM may include a random access preamble identifier.

As shown by reference number 315, the base station 110 may transmit an RAR as a reply to the preamble. The message that includes the RAR may be referred to as message 2, msg2, MSG2, or a second message in a four-step RACH procedure. In some cases, the RAR may indicate the detected random access preamble identifier (e.g., received from the UE 120 in msg1). In some cases, the RAR may indicate a resource allocation to be used by the UE 120 to transmit message 3 (msg3).

In some cases, as part of the second step of the four-step RACH procedure, the base station 110 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step RACH procedure, the base station 110 may transmit the PDSCH communication for the RAR, as scheduled by the PDCCH communication. The RAR may be included in a MAC PDU of the PDSCH communication.

As shown by reference number 320, the UE 120 may transmit an RRC connection request message. The RRC connection request message may be referred to as message 3, msg3, MSG3, or a third message of a four-step RACH procedure. In some cases, the RRC connection request may include a UE identifier, uplink control information (UCI), and/or a PUSCH communication (e.g., an RRC connection request).

As shown by reference number 325, the base station 110 may transmit an RRC connection setup message. The RRC connection setup message may be referred to as message 4, msg4, MSG4, or a fourth message of a four-step RACH procedure. In some cases, the RRC connection setup message may include the detected UE identifier, a timing advance value, and/or contention resolution information. As shown by reference number 330, if the UE 120 successfully receives the RRC connection setup message, the UE 120 may transmit a HARQ ACK.

In some cases, despite favorable network conditions (e.g., an RSRP from about −70 dBm to about −60 dBm), the UE 120 may fail to successfully perform the four-step RACH procedure (e.g., the UE 120 may experience a RACH attempt failure) or may experience a relatively long delay (e.g., a RACH latency) associated with successfully completing the four-step RACH procedure. For example, the UE 120 may initiate the four-step RACH procedure but encounter consecutive RACH attempt failures based at least in part on failing to receive a fourth message from the base station 110 prior to an expiration of a time associated with receiving the fourth message. The UE 120 may fail to receive the fourth message prior to the expiration of the timer based at least in part on the base station 110 failing to successfully decode the third message of the four-step RACH procedure.

In some cases, the base station 110 may fail to successfully decode the third message based at least in part on the uplink power associated with the transmission of the third message not being high enough to enable the base station 110 to successfully decode the third message. For example, a msg3-DeltaPreamble setting configured by the base station 110 may be too low. Increasing the uplink transmission power for the third message may depend on Msg1 power ramping up (e.g., increasing the uplink transmission power used to transmit the first message according to the msg3-DeltaPreamble setting). Further, the base station 110 may not provide a transmit power control (TPC) command in an RAR included in the second message. Thus, the UE 120 may perform several rounds of RACH procedure attempts until the uplink transmit power for the third message is sufficient to enable the base station 110 to successfully decode the third message. In some cases, the UE 120 may abort the RACH procedure attempts prior to the uplink transmit power being incremented to a high enough level to enable the base station 110 to successfully decode the third message. In some cases, the UE 120 may abort the RACH procedure attempts even though the uplink transmit power for the third message has not been incremented to a maximum uplink transmit power.

In some cases, the base station 110 may schedule resources for several retransmissions of the third message. However, the base station 110 may not provide a TPC command for the retransmissions of the third message and the UE 120 may utilize the same uplink transmission power for each retransmission of the third message, which may be insufficient to enable the base station 110 to successfully decode the third message.

Some techniques and apparatuses described herein enable UE-based power boosting for retransmitting the third message. In some aspects, the UE 120 may determine that the base station 110 failed to successfully decode a third message of the four-step RACH procedure. The UE 120 may determine whether the Msg3-DeltaPreamble setting satisfies (e.g., is less than) a threshold and whether a TPC command is received from the base station 110. The UE 120 may apply a power boosting algorithm to increase the uplink transmit power for a retransmission of the third message when the Msg3-DeltaPreamble setting satisfies the threshold and when a TPC command associated with retransmitting the third message is not received from the base station 110. In this way, the UE 120 may quickly increase the uplink transmit power to a level that is sufficient to enable the base station 110 to successfully decode the third message.

As indicated above, FIG. 3 is provided as an example. Other examples may differ from what is described with regard to FIG. 3.

FIG. 4 is a diagram illustrating an example associated with UE-based power boosting for retransmission of a message 3 of a four-step RACH procedure, in accordance with the present disclosure. As shown in FIG. 4, a base station 110 and a UE 120 may communicate with one another to perform the four-step RACH procedure.

As shown by reference number 405, the base station 110 may transmit, and the UE 120 may receive, one or more SSBs and random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a RAM and/or one or more parameters for receiving an RAR.

As shown by reference number 410, the UE 120 may transmit a RAM (e.g., a first message of the four-step RACH procedure), which may include a preamble. The random access message may include a random access preamble identifier.

As shown by reference number 415, the base station 110 may transmit an RAR (e.g., a second message of the four-step RACH procedure) as a reply to the preamble. In some aspects, the RAR may indicate the detected random access preamble identifier (e.g., received from the UE 120 in the first message). Additionally, or alternatively, the RAR may indicate a resource allocation to be used by the UE 120 to transmit a third message of the four-step RACH procedure.

In some aspects, as part of the second step of the four-step RACH procedure, the base station 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step RACH procedure, the base station 110 may transmit the PDSCH communication for the RAR, as scheduled by the PDCCH communication. The RAR may be included in a MAC PDU of the PDSCH communication.

As shown by reference number 420, the UE 120 may transmit an RRC connection request message (e.g., a third message of the four-step RACH procedure). In some aspects, the RRC connection request may include a UE identifier, UCI, and/or a PUSCH communication (e.g., an RRC connection request). In some aspects, for the initial transmission of the third message in each round (e.g., steps 1 through 4 for a successful RACH procedure attempt or steps 1 through 3 for an unsuccessful RACH procedure attempt, as described above with respect to FIG. 3 and elsewhere herein) of the four-step RACH procedure, the uplink transmission power (msg3_pwr(i)(0) (e.g., the third message PUSCH transmission power of the initial transmission of the third message in the i^{th} round of the four-step RACH procedure)) may be calculated based at least in part on the uplink transmission power associated with transmitting the first message and the Msg3-DeltaPreamble setting.

As shown by reference number 425, the base station 110 may fail to successfully decode the third message of the four-step RACH procedure. In some aspects, the UE 120 may determine that the base station 110 failed to successfully decode the third message based at least in part on an expiration of a timer associated with receiving a fourth message of the four-step RACH procedure from the base station 110.

In some aspects, the UE 120 may determine whether a power offset between the third message and the first message satisfies a threshold based at least in part on the base station 110 failing to successfully decode the third message. For example, the UE 120 may determine whether a msg3-DeltaPreamble setting is less than a threshold msg3-DeltaPreamble setting. In some aspects, the threshold may be determined and/or adjusted by the UE 120. In some aspects, the threshold may be configured by the base station 110.

In some aspects, the base station 110 may allocate resources for one or more retransmissions of the third message. In some aspects, the UE 120 may determine whether a TPC command associated with retransmitting the third message is received from the base station 110. The UE 120 may apply a power boosting algorithm to increase the uplink transmission power associated with retransmitting the third message when the power offset between the third message and the first message satisfies the threshold and when a TPC command has not been received from the base station 110.

As shown by reference number 430, the UE 120 may apply a power boosting algorithm to increase the uplink transmit power associated with retransmitting the third message to the base station 110. In some aspects, the uplink transmission power for the third message may be represented by msg3_pwr(i)(j), wherein i indicates a current round of RACH procedure attempts being performed by the UE 120 and j indicates a quantity of transmissions of the third message (e.g., msg3_pwr(1)(0) represents the uplink transmission power for an initial transmission of the third message during a first round of RACH procedure attempts).

In some aspects, for the retransmission of the third message (e.g., j≠0) in the first round (e.g., i=1) of RACH procedure attempts, the UE 120 may determine the uplink transmission power for retransmitting the third message based at least in part on a formula having the form:
msg3_pwr(1)(j)=msg3_pwr(1)(0)+Σ₁^{j}Delta_ue(1)(j)+Σ₁^{j}Delta_tpc(1)(j),
   where Delta_tpc(i)(j) is the TPC command received from DCI for the j^{th} re-transmission in the i^{th} round of RACH procedure attempts; Delta_ue(i)(j) is the UE-based power adjustment step for the j^{th} re-transmission in the i^{th} round of RACH procedure attempts; i is the indexed round of RACH procedure attempts (e.g., i=1, 2, 3,or 4, among other examples); j=0 is the indexed initial transmission of the third message; and j=1 is the indexed re-transmission of the third message in each round of RACH procedure attempts.

In some aspects, the UE 120 may adjust Delta_ue(i)(j) based at least in part on the formula N*Msg1_PowerRampingStep, where Nis an integer value (e.g., 1, 2, 3, or 4, among other examples).

As shown by reference number 435, the UE 120 may retransmit the third message to the base station 110 based at least in part on applying the power boosting algorithm. In some aspects, the base station 110 may fail to successfully decode the retransmitted third message. In some aspects, the UE 120 may apply the power boosting algorithm and may perform a second retransmission of the third message in a manner similar to that described above.

In some aspects, the UE 120 may terminate a current round of RACH procedure attempts and may initiate a second round of RACH procedure attempts based at least in part on the base station 110 failing to successfully decode the retransmitted third message (or any additionally retransmitted third messages). For example, the UE 120 may transmit another first message, may receive another second message, and may transmit another third message that the base station 110 fails to successfully decode, in a manner similar to that described elsewhere herein.

In some aspects, the UE 120 may apply the power boosting algorithm to increase the uplink transmission power for transmitting and/or retransmitting the third message of the second round of RACH procedure attempts. In some aspects, the base station 110 may not schedule resources for retransmitting the third message or may schedule a small number (e.g., 1 or 2) of retransmissions, and the UE 120 may utilize a baseline of the uplink transmission power for retransmitting the third message in a k^{th} round of RACH procedure attempts as the maximum one of: an initial uplink transmission power of the third message in the k^{th} round of RACH procedure attempts, or a last transmission or retransmission uplink transmission power of the third message in the (k−1)^{th} round of RACH procedure attempts.

In some aspects, the UE 120 may apply the power boosting algorithm based at least in part on a formula having the form:
msg3_pwr(k)(j)=max{msg3_pwr(k−1)(m), msg3_pwr(k)(0)}+Σ₁^{j}Delta_ue(k)(j)+Σ₁^{j}Delta_{tpc}(k)(j), where k is the indexed round (e.g., k−2 for the second round) of RACH procedure attempts; and m is the indexed last transmission of a round of RACH procedure attempts.

As shown by reference number 440, the base station 110 may successfully decode the third message (e.g., the retransmitted third message or the third message transmitted during a subsequent round of RACH procedure attempts) and may transmit an RRC connection setup message (e.g., a fourth message of the four-step RACH procedure). In some aspects, the RRC connection setup message may include the detected UE identifier, a timing advance value, and/or contention resolution information. As shown by reference number 445, the UE 120 may successfully receive the RRC connection setup message and may transmit a HARQ ACK.

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 120) performs operations associated with UE-based power boosting for retransmission of message 3 of a four-step RACH procedure.

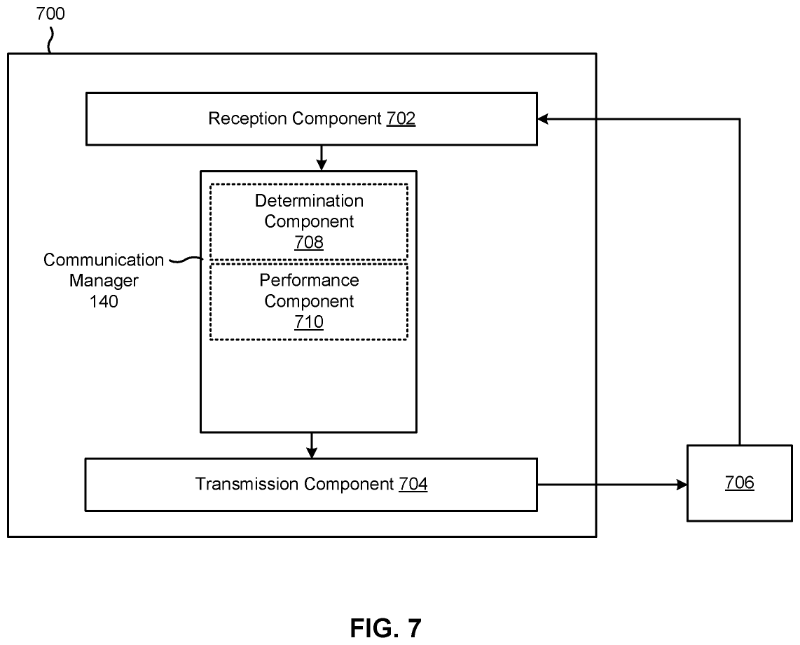

As shown in FIG. 5, in some aspects, process 500 may include transmitting a first message of a four-step RACH procedure to a base station (block 510). For example, the UE (e.g., using communication manager 140 and/or transmission component 704, depicted in FIG. 7) may transmit a first message of a four-step RACH procedure to a base station, as described above.

As further shown in FIG. 5, in some aspects, process 500 may include receiving, from the base station, a second message of the four-step RACH procedure based at least in part on transmitting the first message (block 520). For example, the UE (e.g., using communication manager 140 and/or reception component 702, depicted in FIG. 7) may receive, from the base station, a second message of the four-step RACH procedure based at least in part on transmitting the first message, as described above.

As further shown in FIG. 5, in some aspects, process 500 may include transmitting, to the base station and utilizing an initial uplink transmission power, a third message of the four-step RACH procedure (block 530). For example, the UE (e.g., using communication manager 140 and/or transmission component 704, depicted in FIG. 7) may transmit, to the base station and utilizing an initial uplink transmission power, a third message of the four-step RACH procedure, as described above.

As further shown in FIG. 5, in some aspects, process 500 may include determining that the third message was not successfully decoded by the base station (block 540). For example, the UE (e.g., using communication manager 140 and/or determination component 708, depicted in FIG. 7) may determine that the third message was not successfully decoded by the base station, as described above.

As further shown in FIG. 5, in some aspects, process 500 may include retransmitting the third message based at least in part on applying a power boosting algorithm to increase an uplink transmission power, wherein the power boosting algorithm is applied based at least in part on a power offset between the third message and the first message satisfying a threshold and based at least in part on a TPC command associated with retransmitting the third message not being received from the base station (block 550). For example, the UE (e.g., using communication manager 140 and/or transmission component 704, depicted in FIG. 7) may retransmit the third message based at least in part on applying a power boosting algorithm to increase an uplink transmission power, wherein the power boosting algorithm is applied based at least in part on a power offset between the third message and the first message satisfying a threshold and based at least in part on a TPC command associated with retransmitting the third message not being received from the base station, as described above.

Process 500 may include additional aspects, such as any single aspect or any combination of aspects described below and/or in connection with one or more other processes described elsewhere herein.

In a first aspect, the third message is retransmitted during a first round of a RACH procedure attempt, wherein the base station fails to successfully decode the retransmitted third message, and process 500 includes transmitting, during a second round of a RACH procedure attempt another first message of the four-step RACH procedure to the base station, receiving, from the base station, another second message of the four-step RACH procedure based at least in part on transmitting the first message, and transmitting, to the base station and utilizing a maximum of a third message retransmission power in the second round of the RACH procedure attempt and a last transmission or retransmission power of the third message in the first round of the RACH procedure attempt, another third message of the four-step RACH procedure based at least in part on the second message.

In a second aspect, alone or in combination with the first aspect, the base station fails to successfully decode the retransmitted third message, and process 500 includes performing a retransmission of the third message based at least in part on applying the power boosting algorithm to further increase the uplink transmission power associated with the retransmission of the third message.

In a third aspect, alone or in combination with one or more of the first and second aspects, the base station fails to successfully decode the retransmitted third message, and process 500 includes receiving a TPC command associated with a retransmission of the third message, and performing the retransmission of the third message according to the TPC command.

In a fourth aspect, alone or in combination with one or more of the first through third aspects, the third message is retransmitted utilizing an uplink transmission power determined based at least in part on the power offset between the third message and the first message when the power offset between the third message and the first message fails to satisfy the threshold.

In a fifth aspect, alone or in combination with one or more of the first through fourth aspects, process 500 includes receiving, from the base station, a TPC command associated with the retransmitted third message, and performing a retransmission of the third message utilizing an uplink transmission power indicated by the TPC command associated with the retransmitted third message.

In a sixth aspect, alone or in combination with one or more of the first through fifth aspects, applying the transmission power boosting algorithm includes multiplying a first message power ramping step parameter by N, wherein N is greater than or equal to one.

In a seventh aspect, alone or in combination with one or more of the first through sixth aspects, determining that the third message was not successfully decoded by the base station comprises determining an expiration of a timer associated with a fourth message of the four-step RACH procedure, and determining that the third message was not successfully decoded by the base station based at least in part on the expiration of the timer.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with the present disclosure. Example process 600 is an example where the base station (e.g., base station 110) performs operations associated with UE-based power boosting for retransmission of message 3 of a four-step RACH procedure.

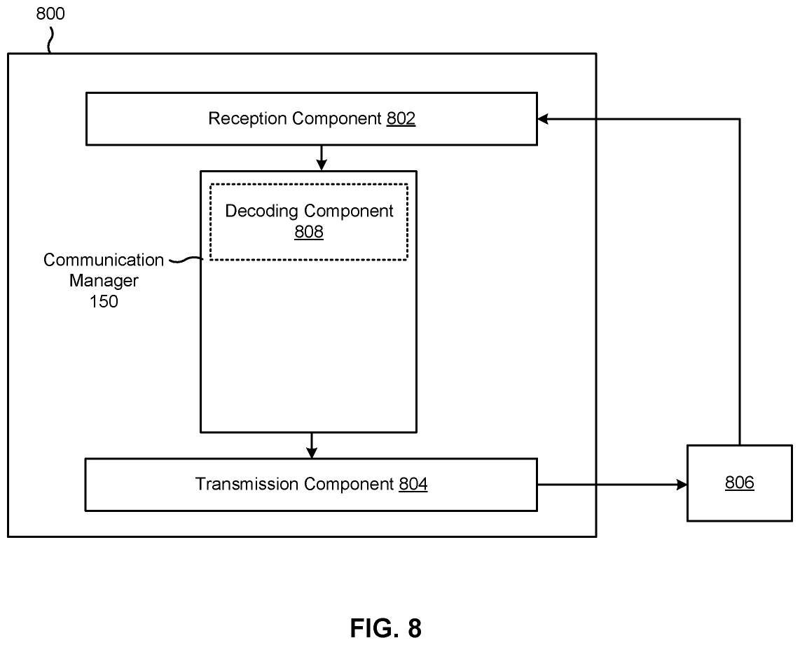

As shown in FIG. 6, in some aspects, process 600 may include receiving, from a UE, a first message of a four-step RACH procedure (block 610). For example, the base station (e.g., using communication manager 150 and/or reception component 802, depicted in FIG. 8) may receive, from a UE, a first message of a four-step RACH procedure, as described above.

As further shown in FIG. 6, in some aspects, process 600 may include

transmitting, to the UE, a second message of the four-step RACH procedure based at least in part on receiving the first message (block 620). For example, the base station (e.g., using communication manager 150 and/or transmission component 804, depicted in FIG. 8) may transmit, to the UE, a second message of the four-step RACH procedure based at least in part on receiving the first message, as described above.

As further shown in FIG. 6, in some aspects, process 600 may include receiving a third message of the four-step RACH procedure, wherein the base station fails to successfully decode the third message (block 630). For example, the base station (e.g., using communication manager 150 and/or reception component 802, depicted in FIG. 8) may receive a third message of the four-step RACH procedure, wherein the base station fails to successfully decode the third message, as described above.

As further shown in FIG. 6, in some aspects, process 600 may include receiving a retransmission of the third message based at least in part on the UE applying a power boosting algorithm to increase the uplink transmission power, wherein the power boosting algorithm is applied based at least in part on a power offset between the third message and the first message satisfying a threshold and based at least in part on a TPC command associated with retransmitting the third message not being received from the base station (block 640). For example, the base station (e.g., using communication manager 150 and/or reception component 802, depicted in FIG. 8) may receive a retransmission of the third message based at least in part on the UE applying a power boosting algorithm to increase the uplink transmission power, wherein the power boosting algorithm is applied based at least in part on a power offset between the third message and the first message satisfying a threshold and based at least in part on a TPC command associated with retransmitting the third message not being received from the base station, as described above.

Process 600 may include additional aspects, such as any single aspect or any combination of aspects described below and/or in connection with one or more other processes described elsewhere herein.

In a first aspect, the third message is retransmitted during a first round of RACH procedure attempts, wherein the base station fails to successfully decode the retransmitted third message, and process 600 includes receiving, during a second round of RACH procedure attempts, another first message of the four-step RACH procedure, transmitting another second message of the four-step RACH procedure based at least in part on receiving the first message, and receiving another third message of the four-step RACH procedure based at least in part on the second message, wherein the other third message is transmitted utilizing a maximum of a third message retransmission power in the second round of the RACH procedure attempt and a last transmission or retransmission power of the third message in the first round of the RACH procedure attempt.

In a second aspect, alone or in combination with the first aspect, the base station fails to successfully decode the retransmitted third message, and process 600 includes transmitting a TPC command associated with a retransmission of the third message, and receiving the retransmission of the third message according to the TPC command.

In a third aspect, alone or in combination with one or more of the first and second aspects, the third message is retransmitted utilizing an uplink transmission power determined based at least in part on the power offset between the third message and the first message when the power offset between the third message and the first message fails to satisfy the threshold.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include one or more of a determination component 708 and a performance component 710, among other examples.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The transmission component 704 may transmit a first message of a four-step RACH procedure to a base station. The reception component 702 may receive, from the base station, a second message of the four-step RACH procedure based at least in part on transmitting the first message. The transmission component 704 may transmit, to the base station and utilizing an initial uplink transmission power, a third message of the four-step RACH procedure. The determination component 708 may determine that the third message was not successfully decoded by the base station. The transmission component 704 may retransmit the third message based at least in part on applying a power boosting algorithm to increase an uplink transmission power, wherein the power boosting algorithm is applied based at least in part on a power offset between the third message and the first message satisfying a threshold and based at least in part on a TPC command associated with retransmitting the third message not being received from the base station.

The reception component 702 may receive, from the base station, a TPC command associated with the retransmitted third message.

The performance component 710 may perform a retransmission of the third message utilizing an uplink transmission power indicated by the TPC command associated with the retransmitted third message.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a base station, or a base station may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 150. The communication manager 150 may include a decoding component 808, among other examples.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the base station described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the base station described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the base station described in connection with FIG. 2. In some aspects, the transmission component 804 may be co-located with the reception component 802 in a transceiver.

The reception component 802 may receive, from a UE, a first message of a four-step RACH procedure. The transmission component 804 may transmit, to the UE, a second message of the four-step RACH procedure based at least in part on receiving the first message. The reception component 802 may receive a third message of the four-step RACH procedure. The decoding component 808 may fail to successfully decode the third message. The reception component 802 may receive a retransmission of the third message based at least in part on the UE applying a power boosting algorithm to increase the uplink transmission power, wherein the power boosting algorithm is applied based at least in part on a power offset between the third message and the first message satisfying a threshold and based at least in part on a TPC command associated with retransmitting the third message not being received from the base station.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a UE, comprising: transmitting a first message of a four-step RACH procedure to a base station; receiving, from the base station, a second message of the four-step RACH procedure based at least in part on transmitting the first message; transmitting, to the base station and utilizing an initial uplink transmission power, a third message of the four-step RACH procedure; determining that the third message was not successfully decoded by the base station; and retransmitting the third message based at least in part on applying a power boosting algorithm to increase an uplink transmission power, wherein the power boosting algorithm is applied based at least in part on a power offset between the third message and the first message satisfying a threshold and based at least in part on a TPC command associated with retransmitting the third message not being received from the base station.

Aspect 2: The method of Aspect 1, wherein the third message is retransmitted during a first round of a RACH procedure attempt, wherein the base station fails to successfully decode the retransmitted third message, the method further comprising: transmitting, during a second round of a RACH procedure attempt another first message of the four-step RACH procedure to the base station; receiving, from the base station, another second message of the four-step RACH procedure based at least in part on transmitting the first message; and transmitting, to the base station and utilizing a maximum of a third message retransmission power in the second round of the RACH procedure attempt and a last transmission or retransmission power of the third message in the first round of the RACH procedure attempt, another third message of the four-step RACH procedure based at least in part on the second message.

Aspect 3: The method of one or more of Aspects 1 and 2, wherein the base station fails to successfully decode the retransmitted third message, the method further comprising: performing a retransmission of the third message based at least in part on applying the power boosting algorithm to further increase the uplink transmission power associated with the retransmission of the third message.

Aspect 4: The method of one or more of Aspects 1 through 3, wherein the base station fails to successfully decode the retransmitted third message, the method further comprising: receiving a TPC command associated with a retransmission of the third message; and performing the retransmission of the third message according to the TPC command.

Aspect 5: The method of one or more of Aspects 1 through 4, wherein the third message is retransmitted utilizing an uplink transmission power determined based at least in part on the power offset between the third message and the first message when the power offset between the third message and the first message fails to satisfy the threshold.

Aspect 6: The method of one or more of Aspects 1 through 5, further comprising: receiving, from the base station, a TPC command associated with the retransmitted third message; and performing a retransmission of the third message utilizing an uplink transmission power indicated by the TPC command associated with the retransmitted third message.

Aspect 7: The method of one or more of Aspects 1 through 6, wherein applying the transmission power boosting algorithm includes multiplying a first message power ramping step parameter by N, wherein N is greater than or equal to one.

Aspect 8: The method of one or more of Aspects 1 through 7, wherein determining that the third message was not successfully decoded by the base station comprises: determining an expiration of a timer associated with a fourth message of the four-step RACH procedure; and determining that the third message was not successfully decoded by the base station based at least in part on the expiration of the timer.

Aspect 9: A method of wireless communication performed by a base station, comprising: receiving, from a UE, a first message of a four-step RACH procedure; transmitting, to the UE, a second message of the four-step RACH procedure based at least in part on receiving the first message; receiving a third message of the four-step RACH procedure, wherein the base station fails to successfully decode the third message; and receiving a retransmission of the third message based at least in part on the UE applying a power boosting algorithm to increase the uplink transmission power, wherein the power boosting algorithm is applied based at least in part on a power offset between the third message and the first message satisfying a threshold and based at least in part on a TPC command associated with retransmitting the third message not being received from the base station.

Aspect 10: The method of Aspect 9, wherein the third message is retransmitted during a first round of RACH procedure attempts, wherein the base station fails to successfully decode the retransmitted third message, the method further comprising: receiving, during a second round of RACH procedure attempts, another first message of the four-step RACH procedure; transmitting another second message of the four-step RACH procedure based at least in part on receiving the first message; and receiving another third message of the four-step RACH procedure based at least in part on the second message, wherein the other third message is transmitted utilizing a maximum of a third message retransmission power in the second round of the RACH procedure attempt and a last transmission or retransmission power of the third message in the first round of the RACH procedure attempt.

Aspect 11: The method of one or more of Aspects 9 and 10, wherein the base station fails to successfully decode the retransmitted third message, the method further comprising: transmitting a TPC command associated with a retransmission of the third message; and receiving the retransmission of the third message according to the TPC command.

Aspect 12: The method of one or more of Aspects 9 through 11, wherein the third message is retransmitted utilizing an uplink transmission power determined based at least in part on the power offset between the third message and the first message when the power offset between the third message and the first message fails to satisfy the threshold.

Aspect 13: An apparatus for wireless communication at a device, comprising a processor; memory coupled with the processor; and instructions stored in the memory and executable by the processor to cause the apparatus to perform the method of one or more of Aspects 1 through 8.

Aspect 14: A device for wireless communication, comprising a memory and one or more processors coupled to the memory, the one or more processors configured to perform the method of one or more of Aspects 1 through 8.

Aspect 15: An apparatus for wireless communication, comprising at least one means for performing the method of one or more of Aspects 1 through 8.

Aspect 16: A non-transitory computer-readable medium storing code for wireless communication, the code comprising instructions executable by a processor to perform the method of one or more of Aspects 1 through 8.

Aspect 17: A non-transitory computer-readable medium storing a set of instructions for wireless communication, the set of instructions comprising one or more instructions that, when executed by one or more processors of a device, cause the device to perform the method of one or more of Aspects 1 through 8.

Aspect 18: An apparatus for wireless communication at a device, comprising a processor; memory coupled with the processor; and instructions stored in the memory and executable by the processor to cause the apparatus to perform the method of one or more of Aspects 9 through 12.

Aspect 19: A device for wireless communication, comprising a memory and one or more processors coupled to the memory, the one or more processors configured to perform the method of one or more of Aspects 9 through 12.

Aspect 20: An apparatus for wireless communication, comprising at least one means for performing the method of one or more of Aspects 9 through 12.

Aspect 21: A non-transitory computer-readable medium storing code for wireless communication, the code comprising instructions executable by a processor to perform the method of one or more of Aspects 9 through 12.

Aspect 22: A non-transitory computer-readable medium storing a set of instructions for wireless communication, the set of instructions comprising one or more instructions that, when executed by one or more processors of a device, cause the device to perform the method of one or more of Aspects 9 through 12.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit a first message of a four-step random access channel (RACH) procedure to a base station;
receive, from the base station, a second message of the four-step RACH procedure based at least in part on transmitting the first message;
transmit, to the base station and utilizing an initial uplink transmission power, a third message of the four-step RACH procedure;
determine that the third message was not successfully decoded by the base station; and
retransmit the third message based at least in part on applying a power boosting algorithm to increase an uplink transmission power, wherein the power boosting algorithm is applied based at least in part on a power offset between the third message and the first message satisfying a threshold and based at least in part on a transmit power control (TPC) command associated with retransmitting the third message not being received from the base station.

2. The UE of claim 1, wherein the third message is retransmitted during a first round of a RACH procedure attempt, wherein the base station fails to successfully decode the retransmitted third message, wherein the one or more processors are further configured to:
transmit, during a second round of a RACH procedure attempt another first message of the four-step RACH procedure to the base station;
receive, from the base station, another second message of the four-step RACH procedure based at least in part on transmitting the first message; and
transmit, to the base station and utilizing a maximum of a third message retransmission power in the second round of the RACH procedure attempt and a last transmission or retransmission power of the third message in the first round of the RACH procedure attempt, another third message of the four-step RACH procedure based at least in part on the second message.

3. The UE of claim 1, wherein the base station fails to successfully decode the retransmitted third message, wherein the one or more processors are further configured to:
perform a retransmission of the third message based at least in part on applying the power boosting algorithm to further increase the uplink transmission power associated with the retransmission of the third message.

4. The UE of claim 1, wherein the base station fails to successfully decode the retransmitted third message, wherein the one or more processors are further configured to:
receive a TPC command associated with a retransmission of the third message; and
perform the retransmission of the third message according to the TPC command.

5. The UE of claim 1, wherein the third message is retransmitted utilizing an uplink transmission power determined based at least in part on the power offset between the third message and the first message when the power offset between the third message and the first message fails to satisfy the threshold.

6. The UE of claim 1, wherein the one or more processors are further configured to:
receive, from the base station, a TPC command associated with the retransmitted third message; and
perform a retransmission of the third message utilizing an uplink transmission power indicated by the TPC command associated with the retransmitted third message.

7. The UE of claim 1, wherein applying the power boosting algorithm includes multiplying a first message power ramping step parameter by N, wherein N is greater than or equal to one.

8. The UE of claim 1, wherein the one or more processors, to determine that the third message was not successfully decoded by the base station, are configured to:
determine an expiration of a timer associated with a fourth message of the four-step RACH procedure; and
determine that the third message was not successfully decoded by the base station based at least in part on the expiration of the timer.

9. A method of wireless communication performed by a user equipment (UE), comprising:
transmitting a first message of a four-step random access channel (RACH) procedure to a base station;
receiving, from the base station, a second message of the four-step RACH procedure based at least in part on transmitting the first message;
transmitting, to the base station and utilizing an initial uplink transmission power, a third message of the four-step RACH procedure;
determining that the third message was not successfully decoded by the base station; and
retransmitting the third message based at least in part on applying a power boosting algorithm to increase an uplink transmission power, wherein the power boosting algorithm is applied based at least in part on a power offset between the third message and the first message satisfying a threshold and based at least in part on a transmit power control (TPC) command associated with retransmitting the third message not being received from the base station.

10. The method of claim 9, wherein the third message is retransmitted during a first round of a RACH procedure attempt, wherein the base station fails to successfully decode the retransmitted third message, the method further comprising:
transmitting, during a second round of a RACH procedure attempt another first message of the four-step RACH procedure to the base station;
receiving, from the base station, another second message of the four-step RACH procedure based at least in part on transmitting the first message; and
transmitting, to the base station and utilizing a maximum of a third message retransmission power in the second round of the RACH procedure attempt and a last transmission or retransmission power of the third message in the first round of the RACH procedure attempt, another third message of the four-step RACH procedure based at least in part on the second message.

11. The method of claim 9, wherein the base station fails to successfully decode the retransmitted third message, the method further comprising:
performing a retransmission of the third message based at least in part on applying the power boosting algorithm to further increase the uplink transmission power associated with the retransmission of the third message.

12. The method of claim 9, wherein the base station fails to successfully decode the retransmitted third message, the method further comprising:
receiving a TPC command associated with a retransmission of the third message; and
performing the retransmission of the third message according to the TPC command.

13. The method of claim 9, wherein the third message is retransmitted utilizing an uplink transmission power determined based at least in part on the power offset between the third message and the first message when the power offset between the third message and the first message fails to satisfy the threshold.

14. The method of claim 9, further comprising:
receiving, from the base station, a TPC command associated with the retransmitted third message; and
performing a retransmission of the third message utilizing an uplink transmission power indicated by the TPC command associated with the retransmitted third message.

15. The method of claim 9, wherein applying the transmission power boosting algorithm includes multiplying a first message power ramping step parameter by N, wherein N is greater than or equal to one.

16. The method of claim 9, wherein determining that the third message was not successfully decoded by the base station comprises:
determining an expiration of a timer associated with a fourth message of the four-step RACH procedure; and
determining that the third message was not successfully decoded by the base station based at least in part on the expiration of the timer.

17. A non-transitory computer-readable medium storing a set of instructions for wireless communication, the set of instructions comprising:
one or more instructions that, when executed by one or more processors of a user equipment (UE), cause the UE to:
transmit a first message of a four-step random access channel (RACH) procedure to a base station;
receive, from the base station, a second message of the four-step RACH procedure based at least in part on transmitting the first message;
transmit, to the base station and utilizing an initial uplink transmission power, a third message of the four-step RACH procedure;
determine that the third message was not successfully decoded by the base station; and
retransmit the third message based at least in part on applying a power boosting algorithm to increase an uplink transmission power, wherein the power boosting algorithm is applied based at least in part on a power offset between the third message and the first message satisfying a threshold and based at least in part on a transmit power control (TPC) command associated with retransmitting the third message not being received from the base station.

18. The non-transitory computer-readable medium of claim 17, wherein the third message is retransmitted during a first round of a RACH procedure attempt, wherein the base station fails to successfully decode the retransmitted third message, wherein the one or more instructions further cause the UE to:
transmit, during a second round of a RACH procedure attempt another first message of the four-step RACH procedure to the base station;
receive, from the base station, another second message of the four-step RACH procedure based at least in part on transmitting the first message; and
transmit, to the base station and utilizing a maximum of a third message retransmission power in the second round of the RACH procedure attempt and a last transmission or retransmission power of the third message in the first round of the RACH procedure attempt, another third message of the four-step RACH procedure based at least in part on the second message.

19. The non-transitory computer-readable medium of claim 17, wherein the one or more instructions further cause the UE to:
perform a retransmission of the third message based at least in part on applying the power boosting algorithm to further increase the uplink transmission power associated with the retransmission of the third message.

20. The non-transitory computer-readable medium of claim 17, wherein the one or more instructions further cause the UE to:
receive a TPC command associated with a retransmission of the third message; and
perform the retransmission of the third message according to the TPC command.

21. The non-transitory computer-readable medium of claim 17, wherein the third message is retransmitted utilizing an uplink transmission power determined based at least in part on the power offset between the third message and the first message when the power offset between the third message and the first message fails to satisfy the threshold.

22. The non-transitory computer-readable medium of claim 17, wherein the one or more instructions further cause the UE to:
receive, from the base station, a TPC command associated with the retransmitted third message; and
perform a retransmission of the third message utilizing an uplink transmission power indicated by the TPC command associated with the retransmitted third message.

23. The non-transitory computer-readable medium of claim 17, wherein the one or more instructions to apply the transmission power boosting algorithm further cause the UE to:
multiply a first message power ramping step parameter by N, wherein N is greater than or equal to one.

24. The non-transitory computer-readable medium of claim 17, wherein the one or more instructions, that cause the UE to determine that the third message was not successfully decoded by the base station, cause the UE to:
determine an expiration of a timer associated with a fourth message of the four-step RACH procedure; and
determine that the third message was not successfully decoded by the base station based at least in part on the expiration of the timer.

25. An apparatus for wireless communication, comprising:
means for transmitting a first message of a four-step random access channel (RACH) procedure to a base station;
means for receiving, from the base station, a second message of the four-step RACH procedure based at least in part on transmitting the first message;
means for transmitting, to the base station and utilizing an initial uplink transmission power, a third message of the four-step RACH procedure;
means for determining that the third message was not successfully decoded by the base station; and
means for retransmitting the third message based at least in part on applying a power boosting algorithm to increase an uplink transmission power, wherein the power boosting algorithm is applied based at least in part on a power offset between the third message and the first message satisfying a threshold and based at least in part on a transmit power control (TPC) command associated with retransmitting the third message not being received from the base station.

26. The apparatus of claim 25, wherein the third message is retransmitted during a first round of a RACH procedure attempt, wherein the base station fails to successfully decode the retransmitted third message, the apparatus further comprising:
means for transmitting, during a second round of a RACH procedure attempt another first message of the four-step RACH procedure to the base station;
means for receiving, from the base station, another second message of the four-step RACH procedure based at least in part on transmitting the first message; and
means for transmitting, to the base station and utilizing a maximum of a third message retransmission power in the second round of the RACH procedure attempt and a last transmission or retransmission power of the third message in the first round of the RACH procedure attempt, another third message of the four-step RACH procedure based at least in part on the second message.

27. The apparatus of claim 25, further comprising:
means for performing a retransmission of the third message based at least in part on applying the power boosting algorithm to further increase the uplink transmission power associated with the retransmission of the third message.

28. The apparatus of claim 25, further comprising:
means for receiving a TPC command associated with a retransmission of the third message; and
means for performing the retransmission of the third message according to the TPC command.

29. The apparatus of claim 25, wherein the third message is retransmitted utilizing an uplink transmission power determined based at least in part on the power offset between the third message and the first message when the power offset between the third message and the first message fails to satisfy the threshold.

30. The apparatus of claim 25, further comprising:
means for receiving, from the base station, a TPC command associated with the retransmitted third message; and
means for performing a retransmission of the third message utilizing an uplink transmission power indicated by the TPC command associated with the retransmitted third message.
